(19) United States
(12) Patent Application Publication
(10) Pub. No.: US 2010/0060878 A1
(43) Pub. Date: Mar. 11, 2010

(54) EXPOSURE APPARTUS, EXPOSURE METHOD AND METHOD OF MANUFACTURING DISPLAY PANEL SUBSTRATE

(75) Inventors: RYOUJI NEMOTO, SAITAMA (JP); TOMOAKI HAYASHI, SAITAMA (JP); SATOSHI UEHARA, SAITAMA (JP); MITSUYOSHI KOIZUMI, SAITAMA (JP); HIDETSUGU YUKI, SAITAMA (JP)

Correspondence Address: J C PATENTS, 4 VENTURE, SUITE 250, IRVINE, CA, 92618, US

(73) Assignee: HITACHI HIGH-TECHNOLOGIES CORPORATION, Tokyo (JP)

(21) Appl. No.: 12/539,281

(22) Filed: Aug. 11, 2009

(30) Foreign Application Priority Data
Sep. 5, 2008 (JP) 2008-228176

(51) Int. Cl. G03B 27/58; G01B 11/14; G03B 27/32

(52) U.S. Cl. 355/74; 356/614; 355/77

(57) ABSTRACT

A chuck 10 which supports a substrate 1 is moved by using an X-direction stage 5, and a position of the chuck 10 is detected at the same time. A traveling error of the X-direction stage 5 is detected according to a detecting result of position of the chuck 10. Then, a coordinate of drawing data supplied to a driving circuit 27 of a light beam irradiation device 20 is modified according to a detecting result of the traveling error of the X-direction stage 5, and the patterned data having the modified coordinate is supplied to the driving circuit 27 of the light beam irradiation device 20. Even if the traveling error such as shifting or yawing occurs in the X-direction stage 5, patterns can still be precisely drawn.

### CROSS-REFERENCE TO RELATED APPLICATION

This application claims the priority of Japanese application serial no. 2008-228176, filed Sep. 5, 2008. All disclosure of the Japanese application is incorporated herein by reference.

### BACKGROUND OF THE INVENTION

1. Field of the Invention

The present invention is related to an exposure apparatus, an exposure method, and a method of manufacturing a display panel substrate which adopts the foregoing exposure apparatus and method, wherein the exposure apparatus and the exposure method are used for emitting a light beam to irradiate a substrate coated with a photoresist, scanning the substrate with the light beam to draw a pattern on the substrate in the manufacturing of the display panel substrates of liquid crystal display devices. In particular, the present invention is related to an exposure apparatus and an exposure method which involve using a stage to move a chuck which supports a substrate and scanning the substrate by a light beam, and is related to a method of manufacturing a display panel which adopts the exposure apparatus and the exposure method.

2. Description of Related Art

Thin film transistor (TFT) substrates, color filter substrates, plasma display panel substrates, or electroluminescence (EL) display panel substrates used as display panels of liquid crystal display devices are manufactured by performing photolithography technologies to form patterns on substrates with use of exposure apparatuses. The following methods have been used in conventional exposure apparatuses: a projection method in which a pattern of a photomask (mask) pattern is projected on a substrate by using lenses or mirrors, a proximity method in which extremely small gaps (proximity gaps) are disposed between the mask and the substrate, for transferring the pattern of the mask onto the substrate.

In recent years, a kind of exposure apparatus as described below has been developed. In the exposure apparatus, a substrate having a photoresist coated thereon is irradiated by a light beam and scanned by the light beam to draw patterns on the substrate. Since the substrate is scanned by the light beam, and the patterns are directly drawn on the substrate, there is no requirement for expensive masks. In addition, drawing data and scanning programs can be varied for adaptation to various sorts of display panel substrates. This kind of exposure apparatuses are, for example, disclosed in Japanese Patent Publication Number 2003-332221, Japanese Patent Publication Number 2005-353927, and Japanese Patent Publication Number 2007-219011.

The scanning of substrate by the light beams is performed by moving the substrate relative to the light beams. Generally, light beam irradiation devices which include precise optical systems are fixed in certain positions, and a stage is used to move a chuck supporting the substrate. If traveling error such as shifting or yawing occurs, a moving path of the substrate supported by the chuck deviates, and the patterns drawn by the light beam from the light beam irradiation device shifts. As such, the patterns are not drawn precisely, which results in poor pattern quality.

### SUMMARY OF THE INVENTION

The present invention is directed to preventing pattern quality deterioration caused by traveling error when a chuck supporting a substrate is moved by a stage and a light beam is used to scan the substrate.

The present invention is directed to manufacturing display panel substrates having high quality.

A characteristic of the present invention is an exposure apparatus or an exposure method, wherein a chuck supports a substrate coated with a photoresist. The chuck is moved by using a stage. The substrate is scanned by light beams irradiated from a plurality of light beam irradiation devices to drawn patterns on the substrate. The light beam irradiation device has a spatial light modulator which modulates the light beam, a driving circuit which drives the spatial light modulator according to drawing data, and an irradiation optical system which emits the light beam modulated by the spatial light modulator. A characteristic of the exposure apparatus or the exposure method is that the chuck is moved by the stage and the position of the chuck is detected at the same time, and the traveling error of the stage is detected according to the detecting result of the position of the chuck. The detecting result of the traveling error of the stage is then used for modifying a coordinate of the drawing data supplied to the driving circuit of the light beam irradiation device, and the drawing data having the modified coordinate is supplied to the driving circuit of the light beam irradiation device.

The spatial light modulator of the light beam irradiation device is formed by arranging a plurality of light-reflecting micro mirrors along two directions, and angles of the mirrors are varied by the driving circuit according to the drawing data, so as to modulate the light beam irradiating the substrate. The light beam modulated by the spatial light modulator is irradiated from a head of the irradiation optical system of the light beam irradiation device to the substrate supported by the chuck. The stage is used to move the chuck supporting the substrate, while the position of the chuck is detected, and according to the detecting result of the position of the chick, the traveling error of the stage is detected. Afterwards, according to the detecting result of the traveling error of the stage, the coordinate of the drawing data supplied to the driving circuit of the light beam irradiation device is modified. The drawing data having the modified coordinate is then supplied to the driving circuit of the light beam irradiation device, so that even if traveling error such as shifting or yawing occurs in the stage, the patterns are still drawn precisely. Hence, when the stage is used to move the chuck supporting the substrate and the light beam is used to scan the substrate, pattern quality deterioration caused by traveling error is prevented.

Another characteristic of the present invention is that a laser measurement system is used to detect the position of the chuck. The laser measurement system includes a light source generating laser, a reflecting means disposed on the chuck, and an interferometer measuring interference of the laser from the light source and to the laser reflected by the reflecting means. The laser measurement system is used to accurately detect and examine the position of the chuck, so as to precisely position the chuck, and the traveling error of the stage is accurately detected. Hence, the coordinate of the drawing data is accurately modified, so that the patterns are more accurately drawn.

Another characteristic of the present invention is that a plurality of the light beam irradiation devices is disposed, and a plurality of the light beams from the light beam irradiation devices in parallel scans the substrate. When the light beams from the light beam irradiation devices are used to scan the substrate, shifting of the patterns drawn by the laser beams from each light beam irradiation device due to traveling error of the stage is thereby prevented, so that the patterns are precisely drawn. Then, by using the light beams from the light beam irradiation devices to scan the substrate, the total time required for scanning the entire substrate is shortened, thereby shortening the tact time.

Since the substrate may be exposed by using the exposure apparatus or exposure of the present invention to precisely draw the patterns, display panel substrates having high quality can be fabricated.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an exposure apparatus according to an embodiment of the present invention.

FIG. 2 is a lateral view of an exposure apparatus according to an embodiment of the present invention.

FIG. 3 is a front view of an exposure apparatus according to an embodiment of the present invention.

FIG. 4 is a schematic view of a light beam irradiation device.

FIG. 5 illustrates an act of a laser measurement system.

FIG. 6 is a schematic view of a drawing controlling part.

FIGS. 7-10 illustrate scanning a substrate with light beams.

FIG. 11 is a flowchart showing an exemplary process of fabricating a TFT substrate of a liquid crystal display device.

FIG. 12 is a flowchart showing an exemplary process of fabricating a color filter substrate of a liquid crystal display device.

### DESCRIPTION OF EMBODIMENTS

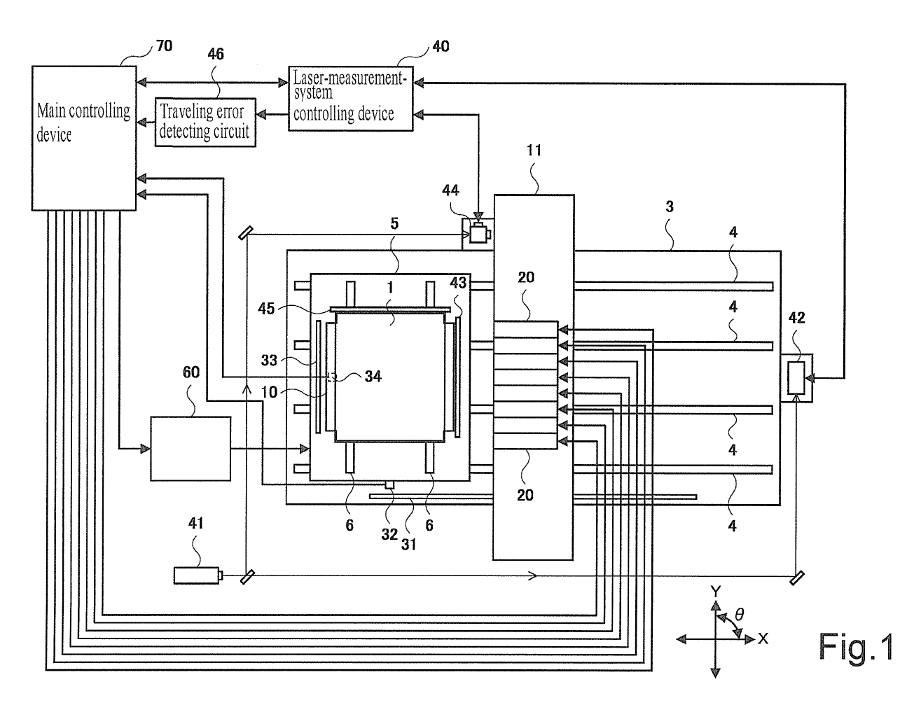

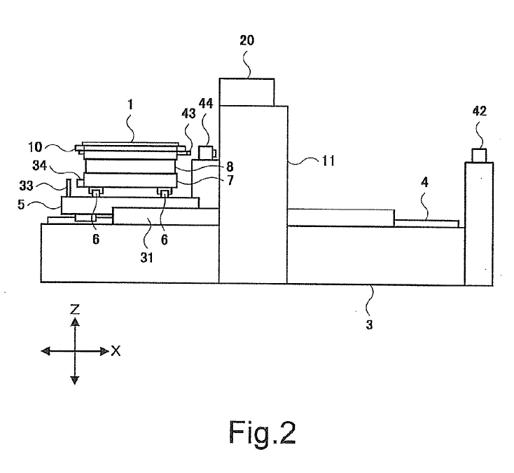

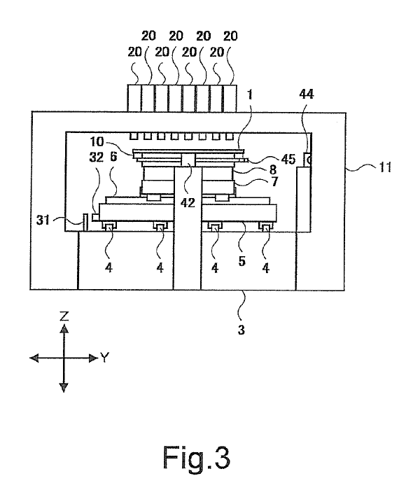

The following embodiments are described with reference to the examples shown in the enclosed figures. FIG. 1 is a schematic view of an exposure apparatus according to an embodiment of the present invention. In addition, FIG. 2 is a lateral view of the exposure apparatus according to an embodiment of the present invention, and FIG. 3 is a front view of the exposure apparatus according to an embodiment of the present invention. The exposure apparatus includes a base 3, an X-direction guide 4, an X-direction stage 5, a Y-direction guide 6, a Y-direction stage 7, a θ-direction stage 8, a chuck 10, a gate 11, light beam irradiation devices 20, linear scales 31 and 33, encoders 32 and 34, a laser measurement system, a laser-measurement-system controlling device 40, a traveling error detecting circuit 46, a stage driving circuit 60, and a main controlling device 70. In addition, in FIG. 2 and FIG. 3, a laser source 41 of the laser measurement system, the laser-measurement-system controlling device 40, the traveling error detecting circuit 46, the stage driving circuit 60, and the main controlling device 70 are omitted. In addition to the above, the exposure apparatus further includes a supply unit for supplying a substrate 1 to the chuck 10, a retrieval unit for retrieving the substrate 1 from the chuck 10, and a temperature controlling unit for managing the temperature inside the apparatus.

The following embodiments are described with reference to the X and the Y directions, but it should be noted that the X direction and the Y direction can be varied.

As shown in FIG. 1 and FIG. 2, the chuck 10 is located in a supply-retrieval position for supplying and retrieving the substrate 1. In the aforesaid position, the substrate 1 is supplied to the chuck 10 by the supply unit (not shown) and retrieved from the chuck 10 by the retrieval unit (not shown). The chuck 10 supports a back side of the substrate 1 by vacuum suction. A surface of the substrate 1 is coated with a photoresist.

Above an exposure position where the substrate 1 is exposed, the gate 11 is disposed across the base 3. The gate 11 carries a plurality of light beam irradiation devices 20 thereon. It should be noted that, although the exposure apparatus described in the present embodiment has only eight light beam irradiation devices 20, the present invention is not limited thereto. Within the spirit and scope of the present invention, the exposure apparatus can include seven or less than seven light beam irradiation devices or nine or more than nine light beam irradiation devices.

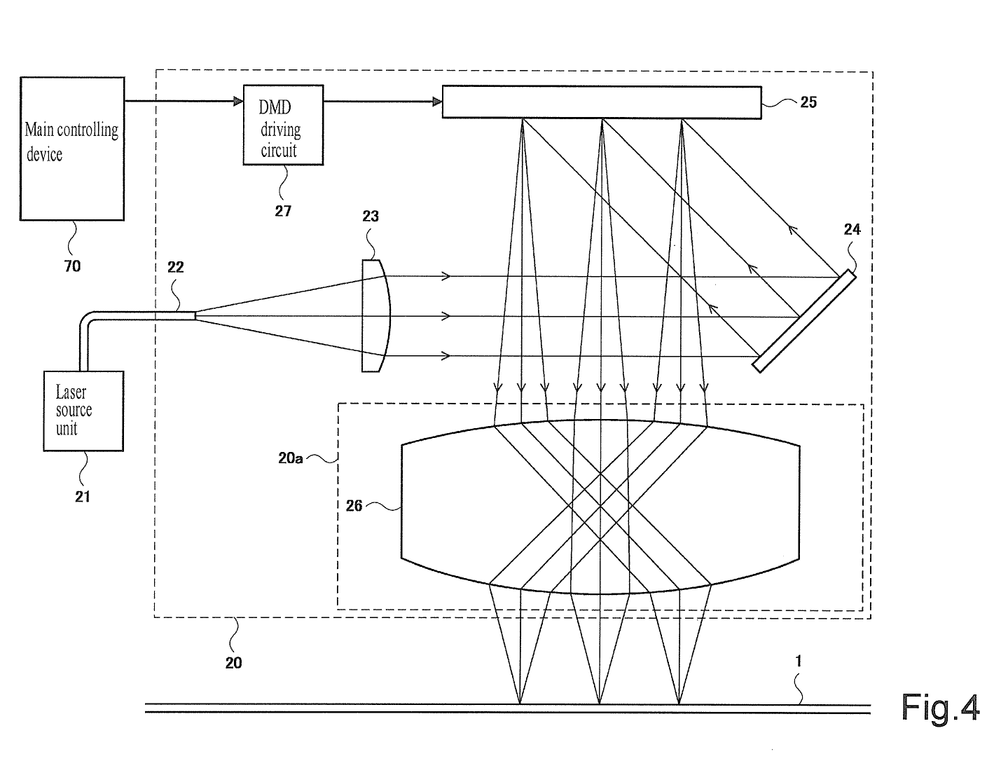

FIG. 4 is a schematic view of a light beam irradiation device. Each of the light beam irradiation devices 20 includes an optical fiber 22, a lens 23, a mirror 24, a digital micro mirror device (DMD) 25, a projection lens 26, and a DMD driving circuit 27. The optical fiber 22 guides an ultraviolet light beam which is generated by the laser source unit 21 into the light beam irradiation device 20. The light beam emitted from the optical fiber 22 irradiates the DMD 25 through the lens 23 and the mirror 24. The DMD 25 is a spatial light modulator formed by arranging a plurality of light-reflecting micro mirrors along two directions, and angles of the mirrors are varied so as to modulate the light beam. The light beam modulated by the DMD 25 is irradiated from a head 20a which contains the projection lens 26. The DMD driving circuit 27 varies the angle of each of the mirrors based on drawing data provided by the main controlling device 70.

Referring to FIG. 2 and FIG. 3, the chuck 10 is disposed on the θ-direction stage 8, and the Y-direction stage 7 and the X-direction stage 5 are disposed under the θ-direction stage 8. The X-direction stage 5 is disposed on the X-direction guide 4 which is disposed on the base 3, and the X-direction stage 5 moves towards the X direction along the X-direction guide 4. The Y-direction stage 7 is disposed on the Y-direction guide 6 which is disposed on the X-direction stage 5, and the Y-direction stage 7 moves towards the Y direction along the Y-direction guide 6. The θ-direction stage 8 is disposed on the Y-direction stage 7 and rotates towards a θ direction.

As the θ-direction stage 8 rotates towards the θ direction, the substrate 1 fixed onto the chuck 10 is rotated in a way that two perpendicular sides of the substrate 1 respectively face the X direction and the Y direction. As the X-direction stage 5 moves towards the X direction, the chuck 10 shifts between the supply-retrieval position and the exposure position. At the exposure position, the light beam irradiated from the head 20a of each of the light beam irradiation devices 20 scans the substrate 1 along the X direction as the X-direction stage 5 moves towards the X direction. Moreover, a region of the substrate 1, which is scanned by the light beam from the head 20a of each of the light beam irradiation devices 20, moves towards the Y direction as the Y-direction stage 7 moves towards the Y direction. Referring to FIG. 1, the stage driving circuit 60 is controlled by the main controlling device 70, so as to rotate the θ-direction stage 8 towards the θ direction, to move the X-direction stage 5 towards the X direction, and to move the Y-direction stage 7 towards the Y direction.

In FIG. 1 and FIG. 2, the linear scale 31 which extends towards the X direction is disposed on the base 3. The linear scale 31 has graduations thereon for measuring a movement of the X-direction stage 5 towards the X direction. Moreover, the linear scale 33 which extends towards the Y direction is disposed on the X-direction stage 5. The linear scale 33 also has graduations thereon for measuring a movement of the Y-direction stage 7 towards the Y direction.

Referring to FIG. 1 and FIG. 3, on one side of the X-direction stage 5, the encoder 32 is disposed opposite to the linear scale 31. The encoder 32 detects the graduations of the linear scale 31 and outputs pulse signals to the main controlling device 70. Further, referring to FIG. 1 and FIG. 2, on one side of the Y-direction stage 7, the encoder 34 is disposed opposite to the linear scale 33. The encoder 34 detects the graduations of the linear scale 33 and outputs pulse signals to the main controlling device 70. The main controlling device 70 counts the pulse signals from the encoder 32 to calculate the movement of the X-direction stage 5 towards the X direction and counts the pulse signals from the encoder 34 to calculate the movement of the Y-direction stage 7 towards the Y direction.

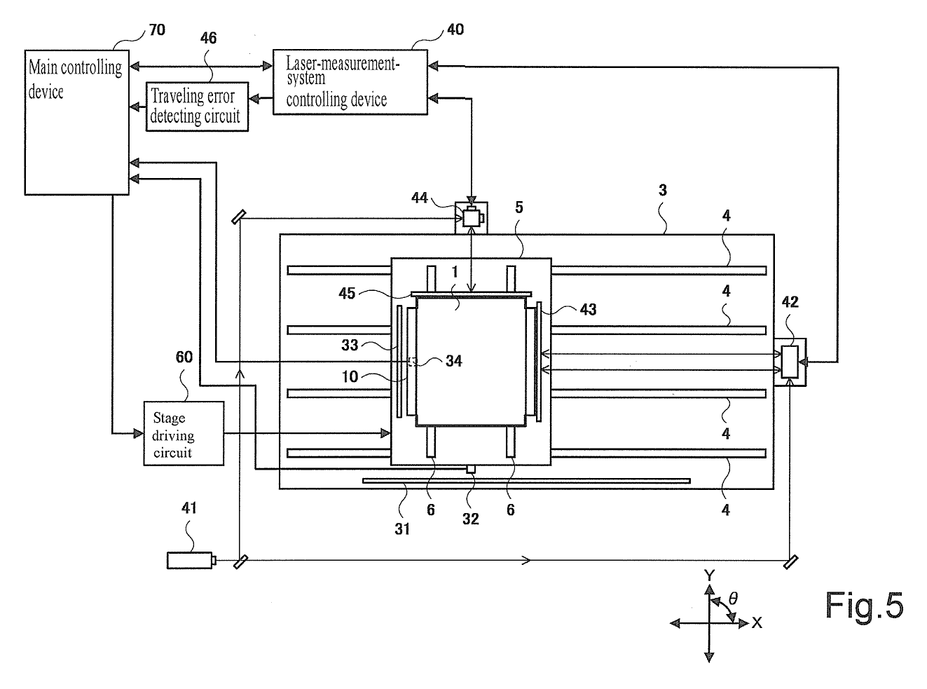

FIG. 5 illustrates an act of a laser measurement system. It should be noted that the gate 11 and the light beam irradiation devices 20 as shown in FIG. 1 are omitted from FIG. 5. The laser measurement system is a commonly-known laser interference measurement system which includes the laser source 41, laser interferometers 42 and 44, bar mirrors 43 and 45. The bar mirror 43 is disposed on one side of the chuck 10 in the Y direction. The bar mirror 45 is disposed on another side of the chuck 10 in the X direction.

The laser interferometer 42 irradiates the bar mirror 43 with the laser from the laser source 41 and receives the laser reflected by the bar mirror 43, so as to measure an interference of the laser from the laser source 41 and the laser reflected by the bar mirror 43. The measurement is performed in two positions along the Y direction. The laser-measurement-system controlling device 40, under control of the main controlling device 70, detects the position and rotation of the chuck 10 in the X direction based on a detecting result generated by the laser interferometer 42.

Furthermore, the laser interferometer 44 irradiates the bar mirror 45 with the laser from the laser source 41 and receives the laser reflected by the bar mirror 45, so as to measure the interference of the laser from the laser source 41 and the laser reflected by the bar mirror 45. The laser-measurement-system controlling device 40, under control of the main controlling device 70, detects the position of the chuck 10 in the Y direction based on a detecting result generated by the laser interferometer 44.

The traveling error detecting circuit 46 detects the traveling error such as shifting or yawing of the X-direction stage 5 moving towards the X direction according to the detecting result of the laser-measurement-system controlling device 40. By using the laser measurement system, the position of the chuck is accurately detected, so that the traveling error of the X-direction stage is also accurately detected. The traveling error detecting circuit 46 outputs the detecting result to the main controlling device 70.

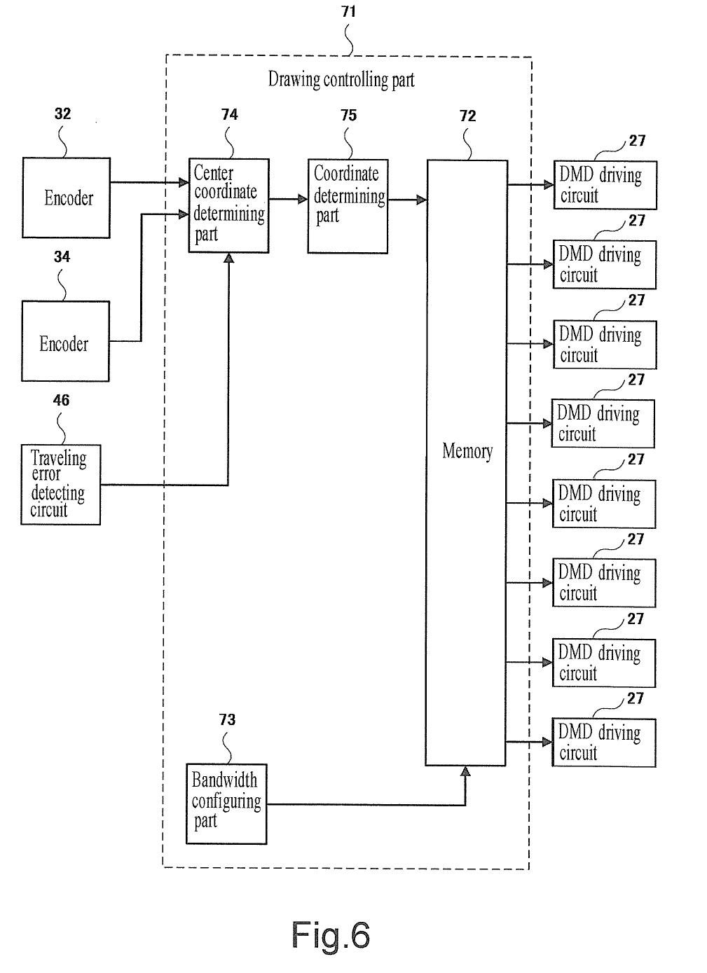

With reference to FIG. 1, the main controlling device 70 includes a drawing controlling part for supplying the drawing data to the DMD driving circuit of the light beam irradiation device 20. FIG. 6 is a schematic view of a drawing controlling part. The drawing controlling part 71 includes a memory 72, a bandwidth configuring part 73, a center coordinate determining part 74, and a coordinate determining part 75. The memory 72 records the XY coordinate of the drawing data as an address. Here, the drawing data is supplied to the DMD driving circuit 27 of each light beam irradiation device 20.

The bandwidth configuring part 73 determines a range of the Y coordinate of the drawing data read from the memory 72, and thereby the bandwidth of the light beam irradiated from the head 20a of the light beam irradiation device 20 in the Y direction is configured.

The center coordinate determining part 74 counts the pulse signals from the encoders 32 and 34, so as to detect and measure the movement of the X-direction stage 5 towards the X direction and the movement of the Y-direction stage 7 towards the Y direction, and thereby the XY coordinate of a center of the chuck 10 is determined. Afterwards, the center coordinate determining part 74 modifies the determined XY coordinate of the center of the chuck 10 according to the detecting result of the traveling error detecting circuit 46.

The coordinate determining part 75 determines the XY coordinate of the drawing data that is supplied to the DMD driving circuit 27 of each light beam irradiation device 20 based on the XY coordinate of the center of the chuck 10 that is determined by the center coordinate determining part 74. The memory 72 inputs the XY coordinate determined by the coordinate determining part 75 as an address and outputs the drawing data recorded in the address of the inputted XY coordinate to the DMD driving circuit 27 of each light beam irradiation device 20.

The traveling error of the X-direction stage 5 is detected, and the coordinate of the drawing data supplied to the DMD driving circuit 27 of the light beam irradiation device 20 is modified according to the detecting result of the traveling error of the X-direction stage 5, so that the drawing data having the modified coordinate is supplied to the DMD driving circuit 27 of each light beam irradiation device 20. Hence, even if traveling error such as shifting or yawing occurs in the X-direction stage, the patterns can still be precisely drawn.

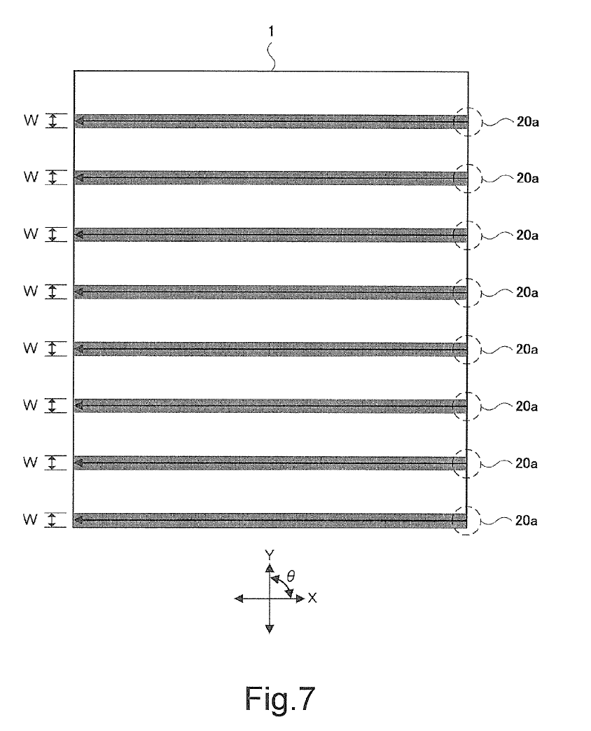

FIGS. 7˜10 illustrate scanning a substrate with light beams. FIGS. 7˜10 show that eight light beams irradiated from eight light beam irradiation devices 20 are used to scan the substrate 1 four times in the X direction, so as to scan the entire substrate 1. In FIGS. 7˜10, the head 20a of each light beam irradiation device 20 is shown by dotted lines. The light beam irradiated from the head 20a of each light beam irradiation device 20 has a bandwidth W in the Y direction, and the light beam scans the substrate 1 along a direction indicated by the arrow as the X-direction stage 5 moves towards the X direction.

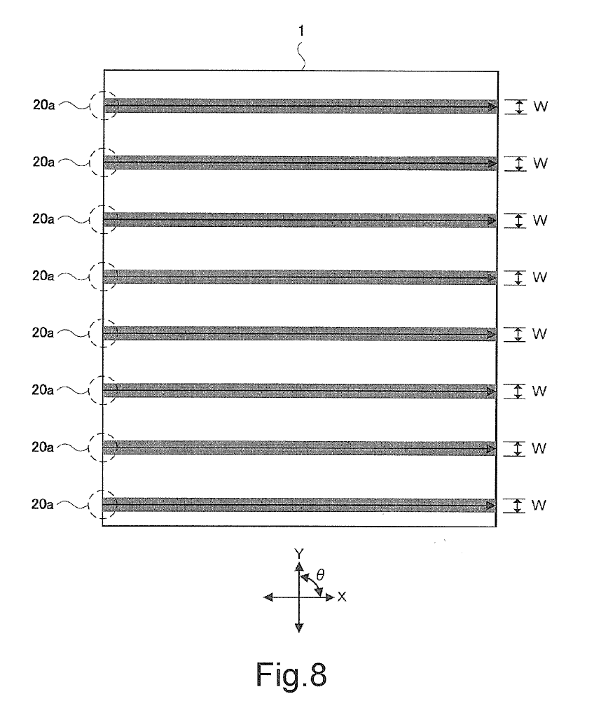

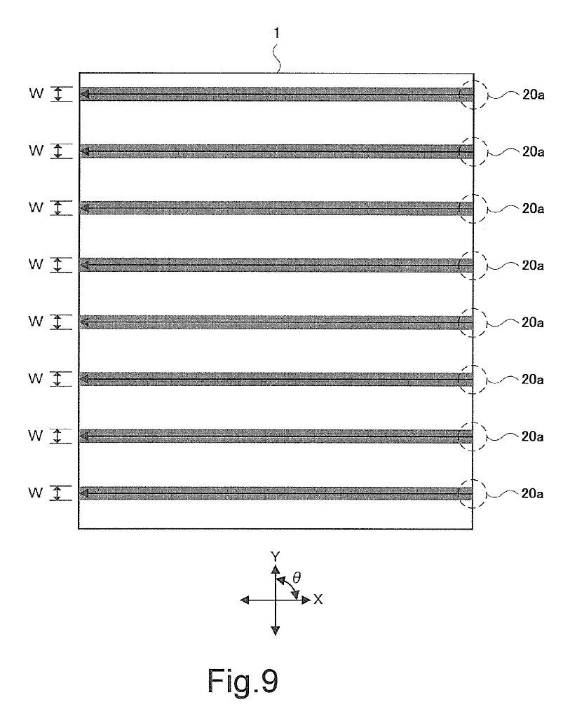

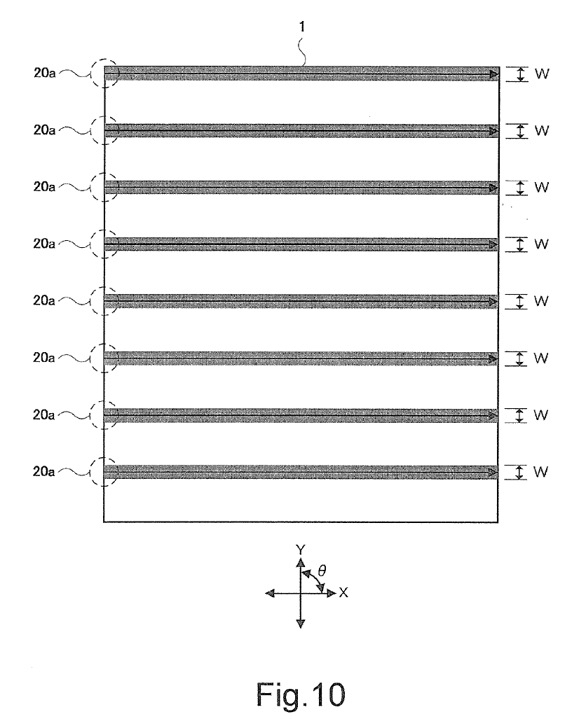

FIG. 7 illustrates the first time of scanning in the X direction to draw patterns in a scan region highlighted with gray in FIG. 7. After the first scanning, the Y-direction stage 7 moves towards the Y direction, so as to move the substrate 1 towards the Y direction for a distance equal to the bandwidth W. FIG. 8 illustrates the second time of scanning in the X direction to draw patterns in the scan region highlighted with gray in FIG. 8. After the second scanning, the Y-direction stage 7 moves towards the Y direction, so as to move the substrate 1 further towards the Y direction for a distance equal to the bandwidth W. FIG. 9 illustrates the third time of scanning in the X direction to draw patterns in the scan region highlighted with gray in FIG. 9. After the third scanning, the Y-direction stage 7 moves towards the Y direction, so as to move the substrate 1 further towards the Y direction for a distance equal to the bandwidth W. FIG. 10 illustrates the fourth time of scanning in the X direction to draw patterns in the scan region highlighted with gray in FIG. 10, thereby completing scanning of the entire substrate 1.

In addition, when the light beams from the light beam irradiation devices 20 are used to scan the substrate 1, deviation of the patterns drawn by the light beams from each light beam irradiation device 20 due to traveling error of the X-direction stage 5 is prevented, so that the patterns are precisely drawn. Afterwards, the light beams from the light beam irradiation devices 20 are used to scan the substrate 1 in parallel, so as to shorten the time required to scan the entire substrate 1, thereby shortening the tact time.

In FIGS. 7˜10, it is exemplarily shown that the substrate 1 is scanned four times in the X direction, so as to scan the entire substrate 1. However, the present invention is not limited thereto. Within the spirit and scope of the present invention, the substrate 1 can also be scanned towards the X direction for three times or less than three times or five times or less than five times, so as to complete the scanning of the entire substrate 1.

According to the above embodiments, the traveling error of the X-direction stage 5 is detected, and the detecting result of the traveling error of the X-direction stage 5 is based on to modify the coordinate of the drawing data supplied to the DMD driving circuit 27 of the light beam irradiation device 20. Further, the drawing data with the modified coordinate is supplied to the DMD driving circuit 27 of the light beam irradiation device 20, such that, even if the traveling error such as shifting or yawing occurs in the X-direction stage 5, the pattern can still be precisely drawn. Therefore, the X-direction stage 5 is used to move the chuck 10 supporting the substrate 1, and when the light beam is used to scan the substrate 1, the traveling error of the X-direction stage 5 causing pattern quality deterioration is prevented.

Furthermore, according to the above-described embodiments, since the laser measurement system is used to detect the position of the chuck 10 accurately, the traveling error of the X-direction stage 5 can be accurately detected. Hence, the coordinate of the patterned data is accurately modified, thereby precisely illustrating and forming the patterns.

Moreover, according to the above-described embodiments, when the light beams from the light beam irradiation devices 20 are used to scan the substrate 1, deviation of the patterns drawn by the light beam from each light beam irradiation device 20 due to the traveling error of the X-direction stage 5 is prevented, so that the patterns are precisely drawn. Afterwards, the light beams from the light beam irradiation devices 20 are used to scan the substrate 1, so as to shorten the time required to scan the entire substrate 1, thereby shortening the tact time.

The exposure apparatus or the exposure method of the present invention can be applied to exposure of the substrate, so as to precisely draw the patterns, and thereby display panel substrates having high quality can be formed.

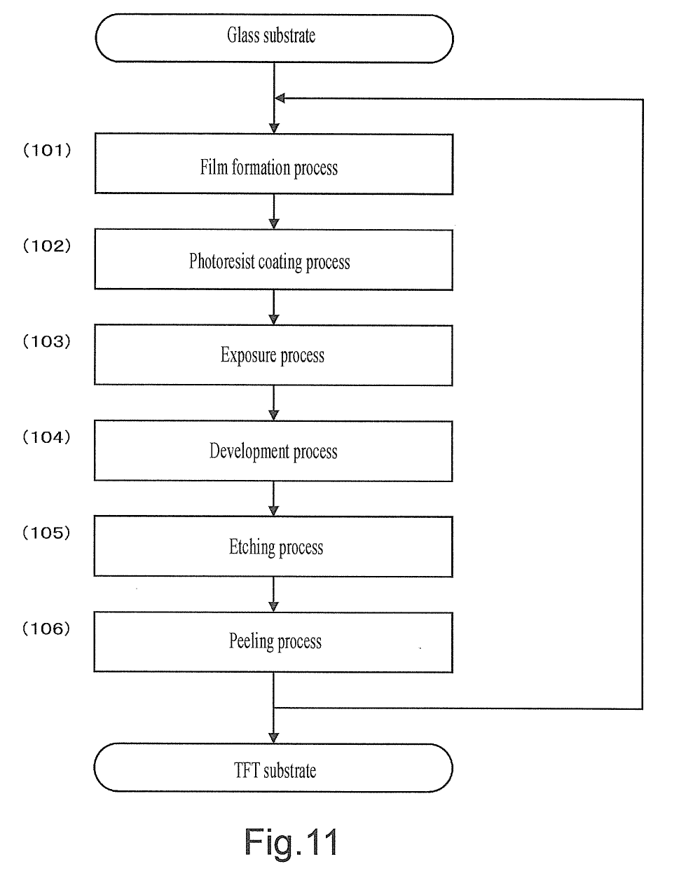

FIG. 11 is a flowchart showing an exemplary process of fabricating a TFT substrate of a liquid crystal display device. In a film formation process (Step 101), a thin film such as a conductive film which serves as a transparent electrode for driving liquid crystals or an insulating film is formed on the substrate by using a sputtering method or a chemical vapor deposition (CVD) method. In a photoresist coating process (Step 102), the photoresist is applied by a roll coating method so as to form a photoresist film on the thin film which is formed in the film formation process (Step 101). In an exposure process (Step 103), a pattern is formed in the photoresist film by using the exposure apparatus. In a development process (Step 104), a development solution is applied onto the photoresist film, so as to remove an unnecessary portion of the photoresist film by using a method such as a shower development method. In an etching process (Step 105), a portion, which is not masked by the photoresist film, of the thin film formed in the film formation process (Step 101) is removed by a wet etching method. In a peeling process (Step 106), the photoresist film which functions as a mask in the etching process (Step 105) is peeled by using a peeling solution. It should be noted that some cleaning or drying processes need to be performed on the substrate before or after each of the aforementioned processes. After the aforementioned processes are repeated for several times, a TFT array is formed on the substrate.

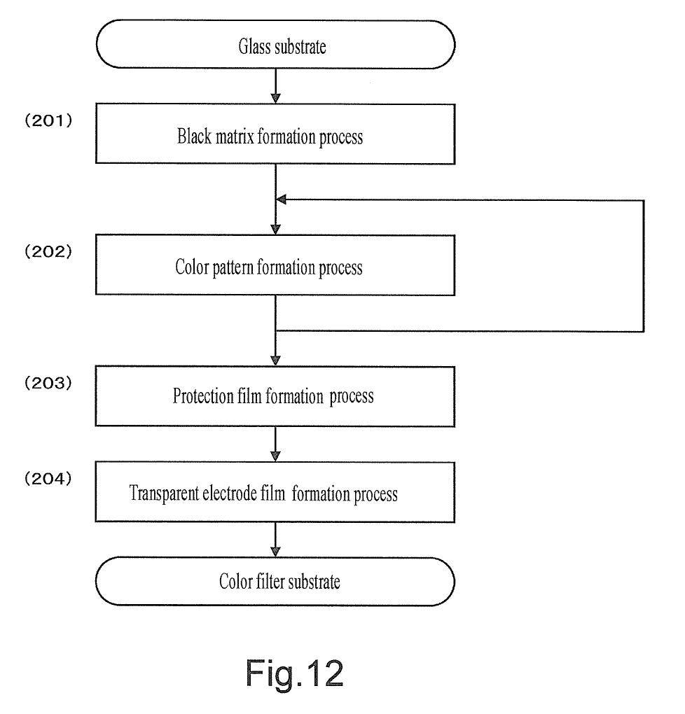

In addition, FIG. 12 is a flowchart showing an exemplary process of fabricating a color filter substrate of a liquid crystal display device. In a black matrix formation process (Step 201), the black matrix is formed on the substrate by the procedures such as photoresist coating, exposure, development, etching, peeling, and so forth. In a color pattern formation process (Step 202), the color pattern is formed on the substrate by using a method such as a printing method. This process can be repeated to form R, G and B color patterns. In a protection film formation process (Step 203), the protection film is formed on the color pattern. Further, in a transparent electrode film formation process (Step 204), the transparent electrode film is formed on the protection film. It should be noted that cleaning or drying processes may need to be performed on the substrate before or during or after each of the aforementioned processes.

In the process of fabricating the TFT substrate as shown in FIG. 11, the exposure apparatus can be used in the exposure process (Step 103), and in the process of fabricating the color filter substrate as shown in FIG. 12, the exposure apparatus or the exposure method of the present invention can be used for exposure in the black matrix formation process (Step 201) and the color pattern formation process (Step 202) of fabricating the color filter substrate.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An exposure apparatus, comprising:
a chuck supporting a substrate coated with a photoresist;
a stage moving the chuck; and
a light beam irradiation device comprising a spatial light modulator modulating a light beam, a driving circuit driving the spatial light modulator according to drawing data, and an irradiation optical system emitting the light beam modulated by the spatial light modulator,
wherein the stage moves the chuck, the substrate is scanned multiple times by a light beam irradiated from the light beam irradiation device to draw patterns on the substrate, the exposure apparatus being characterized by:
a position detecting means detecting a position of the chuck moved by the stage;
a traveling error detecting means detecting traveling error of the stage according to a detecting result of the position detecting means;
a means modifying a coordinate of the drawing data supplied to the driving circuit of the light beam irradiation device according to a detecting result of the traveling error detecting means and supplying the drawing data with the modified coordinate to the driving circuit of the light beam irradiation device.

2. The exposure apparatus as claimed in claim 1, wherein the position detecting means comprises a laser measurement system, and the laser measurement system comprises a light source generating a laser, a reflecting means disposed on the chuck, and an interferometer measuring an interference of the laser generated by the light source and the laser reflected by the reflecting means.

3. The exposure apparatus as claimed in claim 1, comprising a plurality of the light beam irradiation devices, wherein a plurality of the light beams irradiated from the light beam irradiation devices scan the substrate in parallel.

4. An exposure method, comprising:
supporting a substrate coated with a photoresist by a chuck,
moving the chuck by a stage,
scanning the substrate by using a light beam irradiated from a light beam irradiation device to draw patterns on the substrate, the light beam irradiation device comprising a spatial light modulator modulating the light beam, a driving circuit driving the spatial light modulator according to drawing data, and an irradiation optical system emitting the light beam modulated by the spatial light modulator, the exposure method being characterized by:
moving the chuck by the stage and detecting a position of the chuck at the same time;
detecting a traveling error of the stage according to a detecting result of the position of the chuck;
modifying a coordinate of the drawing data supplied to the driving circuit of the light beam irradiation device according to a detecting result of the traveling error of the stage;
supplying the drawing data having the modified coordinate to the driving circuit of the light beam irradiation device.

5. The exposure method as claimed in claim 4, wherein the step of detecting the position of the chuck is performed by using a laser measurement system, and the laser measurement system comprises a light source generating a laser, a reflecting means disposed on the chuck, and an interferometer measuring interference of the laser generated by the light source and the laser reflected by the reflecting means.

6. The exposure method as claimed in claim 4, further comprising disposing a plurality of the light beam irradiation devices; and
scanning the substrate in parallel by using a plurality of the light beams from the light beam irradiation devices.

7. A method of manufacturing a display panel substrate, the method being characterized by adopting the exposure apparatus as claimed in claim 1 to expose a substrate.

8. A method of manufacturing a display panel substrate, the method being characterized by adopting the exposure method as claimed in claim 4 to expose a substrate.
